(19) United States
(12) Patent Application Publication
(10) Pub. No.: US 2018/0191026 A1
(43) Pub. Date: Jul. 5, 2018

(54) PROTECTIVE LAYER HAVING IMPROVED CONTACTING FOR LITHIUM CELLS AND/OR LITHIUM BATTERIES

(71) Applicant: Robert Bosch GmbH, Stuttgart (DE)

(72) Inventors: Joerg Thielen, Stuttgart (DE); Jean Fanous, Kusterdingen (DE); Marcus Wegner, Leonberg (DE)

(21) Appl. No.: 15/851,045

(22) Filed: Dec. 21, 2017

(30) Foreign Application Priority Data
Dec. 29, 2016 (DE) 102016226291.2

(51) Int. Cl. H01M 10/0525; H01M 2/16; H01M 2/18; H01M 10/0562; H01M 4/485; H01M 4/58

(52) U.S. Cl. CPC H01M 10/0525; H01M 2/1686; H01M 2/18; H01M 4/5825; H01M 10/0562; H01M 4/485; H01M 2/1653

(57) ABSTRACT

A separator of a lithium cell or battery includes (I) a protective layer that includes at least one single lithium-ion conducting polyelectrolyte, a lithium-ion conducting or lithium-ion conductive block copolymer, and/or an inorganic lithium-ion conductor, and (II) a contact layer that includes at least one polymer electrolyte made of (a) a lithium-ion conductive polymer that includes a main chain and at least one side chain and (b) at least one lithium conducting salt.

### CROSS-REFERENCE TO RELATED APPLICATIONS

The present application claims priority under 35 U.S.C. § 119 to DE 10 2016 226 291.2, filed in the Federal Republic of Germany on Dec. 29, 2016, the content of which is hereby incorporated by reference herein in its entirety.

### FIELD OF THE INVENTION

The present invention relates to a separator and an electrode for a lithium cell and/or lithium battery, and to a lithium cell and/or lithium battery outfitted therewith and to a method for the manufacture thereof.

### BACKGROUND

Lithium-ion cells and/or lithium-ion batteries can exhibit very high specific energies. For that reason, lithium-ion cells and/or lithium-ion batteries are used nowadays in many electrical devices and in order to electrify automobiles, for example electric cars. In the context of electrification of automobiles, they play a critical role as an energy reservoir.

Cells having even higher specific energies are nevertheless desirable in order to achieve maximum ranges for electric cars.

Lithium metal cells and/or lithium metal batteries having metallic lithium anodes promise higher specific energies than conventional lithium-ion cells and/or lithium-ion batteries having graphite-based anodes.

Metallic lithium formation of lithium dendrites at the anode, can occur during cycling. These lithium dendrites can grow toward the cathode and possibly perforate the separator, and in the event of contact with the cathode can possibly even result in a short circuit.

U.S. Pat. App. Pub. No. 2013/0017432 describes separator systems for electrochemical systems, U.S. Pat. App. Pub. No. 2015/0188108 relates to a separator for an electrical energy reservoir, EP 2 648 265 describes a multiple-ply electrolyte structure for a lithium-ion battery, U.S. Pat. App. Pub. No. 2013/0149616 relates to a lithium titanium oxide anode having a protective layer, DE 10 2013 220 785 describes a lithium electrode, and U.S. Pat. No. 5,925,483 relates to multiple-ply polymeric electrolytes for electrochemical apparatuses.

### SUMMARY

Embodiments of the present invention include or are directed to a separator for a lithium cell and/or lithium battery, in particular for a lithium metal cell and/or lithium metal battery.

The separator encompasses in particular at least one protective layer and at least one contact layer.

The at least one protective layer encompasses in particular at least one single lithium-ion conducting polyelectrolyte and/or at least one lithium-ion conducting or lithium-ion conductive block copolymer and/or at least one inorganic, in particular ceramic or glass-like, lithium-ion conductor.

The at least one contact layer encompasses in particular at least one polymer electrolyte made of at least one lithium-ion conductive polymer and at least one lithium conducting salt, for example a combination of, for instance a mixture of, at least one lithium-ion conductive polymer and at least one lithium conducting salt. The at least one lithium-ion conductive polymer of the at least one polymer electrolyte of the at least one contact layer has, in particular, a main chain and at least one side chain. For example, the at least one lithium-ion conductive polymer of the at least one polymer electrolyte of the at least one contact layer can have at least two side chains.

A “lithium metal cell and/or lithium metal battery” can be understood in particular as a lithium cell and/or lithium battery that has an anode encompassing metallic lithium, for example an anode made of metallic lithium or of a lithium alloy, for instance a metallic lithium anode.

A “single lithium-ion conducting polyelectrolyte” can be understood in particular as a polymer that has anions which are attached covalently to the polymer and are thus, in particular, immobile; and, in particular mobile, lithium ions.

A “lithium-ion conductive polymer” can be understood in particular as a polymer that itself can be free of the ions that are to be conducted, in particular lithium ions, but is suitable for coordinating and/or solvating the ions to be conducted, for example lithium ions, and/or counter-ions to the ions to be conducted, in particular lithium conducting salt ions, and that becomes lithium-ion conducting, for example, upon addition of the ions to be conducted, in particular lithium ions, for instance in the form of at least one lithium conducting salt.

An example embodiment of the present invention is directed to an electrode to be explained in further detail later, for example an anode or a cathode, for a lithium cell and/or lithium battery, in particular for a lithium metal cell and/or lithium metal battery, which encompasses an electrode layer as well as at least one such protective layer and at least one such contact layer, and to a lithium cell and/or lithium battery, to be explained in further detail later, which encompasses at least one such protective layer and/or at least one such contact layer, in particular such a separator and/or such an electrode; and to a method for the manufacture thereof.

Single lithium-ion conducting polyelectrolytes and/or lithium-ion conducting or lithium-ion conductive block copolymers and/or inorganic lithium-ion conductors can advantageously exhibit comparatively high mechanical stability and/or rigidity, in particular as compared with other, in particular lithium-ion conductive, polymers. It is therefore advantageously possible to constitute therefrom a protective layer that has sufficient mechanical stability to prevent lithium dendrites from growing through. Growth of dendrites through to the cathode, and thus short circuits associated therewith, can thus advantageously be avoided or prevented, and the service life of the lithium cell and/or lithium battery outfitted therewith can thereby be extended.

Single lithium-ion conducting polyelectrolytes furthermore have the advantage that they conduct only lithium ions (and, in particular, not their counter-ions), and that only lithium ions are thus available for charge transport. Concentration overvoltages, which might limit or decrease otherwise attainable current densities, can thereby be avoided, and high current densities, including e.g., over long time periods, and wide A-SOC ranges, for instance for a constant high current load, in particular in a charging and discharging direction, can be maintained and, for example, rapid charging of the cell and/or battery can be achieved.

Because the at least one lithium-ion conductive polymer of the at least one polymer electrolyte of the at least one contact layer has a main chain and at least one side chain, its properties in terms of contact promotion between the at least one protective layer and other solid layers, for example an anode or a cathode, and/or the intrinsic lithium-ion conductivity, can be optimized.

Advantageously, for example, the properties, for instance the intrinsic lithium-ion conductivity and/or softness, for example the shear modulus, of the at least one lithium-ion conductive polymer of the at least one polymer electrolyte of the at least one contact layer can be adjusted very effectively by way of the main chain and/or the side chain(s), and, e.g., also via the molecular weight and/or the repeating unit(s) and/or functional groups and/or copolymerization. For example, the at least one lithium-ion conductive polymer of the at least one polymer electrolyte of the at least one contact layer can be adjusted, in particular by way of the main chain and/or the side chain(s), and e.g., also via the molecular weight and/or repeating unit(s) and/or functional groups and/or copolymerization, in such a way that good contact promotion and/or high flexibility, simultaneously with high ionic conductivity, can be ensured. For example, the at least one lithium-ion conductive polymer of the at least one polymer electrolyte of the at least one contact layer can encompass one or more repeating units having a flexible main chain and/or having flexible side groups, and/or can exhibit a low glass transition temperature, in particular a lower glass transition temperature than the at least one single lithium-ion conducting polyelectrolyte and/or the at least one lithium-ion conducting or lithium-ion conductive block copolymer of the at least one protective layer, and/or can be non-crosslinked.

It is thereby advantageously possible, thanks to the at least one lithium-ion conductive polymer having a main chain and at least one side chain in combination with the at least one lithium conducting salt, to furnish a contact layer that is optimized in terms of its contact- and/or adhesion-promoting properties, for instance its flexibility and/or softness, and in terms of its intrinsic lithium-ion conductivity, and can effectively adapt to surfaces and compensate for changes in volume and thus impart a certain flexibility to the rigid or stiff protective layer and serve as a contact promoter between the protective layer and other solid layers, such as the anode and/or cathode. In particular, thanks to the at least one contact layer, contact between the at least one protective layer and other surfaces, in particular contacting between the protective layer and the anode and/or cathode, can be improved and, in particular, maintained even over longer periods of time.

Thanks to the combination of the at least one lithium-conductive polymer having the main chain and the at least one side chain with the at least one lithium conducting salt, it is furthermore advantageously possible to achieve a comparatively high, or in fact higher, intrinsic lithium-ion conductivity than can be obtained with, in particular conventional, single lithium-ion conducting polyelectrolytes and/or lithium-ion conducting or lithium-ion conductive block copolymers and/or inorganic lithium-ion conductors. For example, polymer electrolytes having ethylene oxide units in the main chain and/or side chain(s)—and, for example, lithium bis(trifluoromethanesulfonyl)imide (LiTFSI) as a lithium conducting salt—can exhibit at 80° C. an intrinsic lithium-ion conductivity>10⁻⁵ S/cm. By way of the at least one contact layer it is thus advantageously possible to decrease contact resistance values, in particular solid/solid contact resistance values, or interface resistance values, and thus to increase the power density of the cell and/or battery outfitted therewith and extend the service life of the lithium cell and/or lithium battery outfitted therewith.

All in all, it is thus possible thanks to the combination of the at least one protective layer and the at least one contact layer, for example by way of the separator according to the present invention and/or the electrode according to the present invention and/or the cell according to the present invention, to furnish a lithium cell and/or lithium battery, in particular a lithium metal cell and/or lithium metal battery, having an extended service life, in particular one that can also be used in electric vehicles and/or hybrid vehicles.

The at least one protective layer can be constituted, for example, from (the) at least one single lithium-ion conducting polyelectrolyte and/or (the) at least one lithium-ion conductive or lithium-ion conducting block copolymer and/or (the) at least one inorganic, in particular ceramic and/or glass-like, lithium-ion conductor.

The at least one contact layer can be constituted, for example, from (the) at least one polymer electrolyte; in particular, the at least one polymer electrolyte can be constituted from (the) at least one lithium-ion conductive polymer having a main chain and at least one side chain, in particular at least two side chains, and (the) at least one lithium conducting salt.

In an example embodiment, the at least one lithium-ion conductive polymer of the at least one polymer electrolyte of the at least one contact layer has a main chain and at least two side chains, for example at least three side chains. Its properties in terms of contact promotion between the at least one protective layer and other solid layers, for example the anode or cathode, can thereby be further optimized. Various geometric structures, such as comb polymers, hyper-branched polymers, etcetera, can be implemented by way of the number and/or disposition of the side chains; this can have an advantageous effect on the contact-promoting properties of the at least one contact layer.

In the context of a further embodiment, the at least one lithium-ion conductive polymer of the at least one polymer electrolyte of the at least one contact layer is therefore a comb polymer and/or a branched polymer, for example a hyper-branched polymer.

In the context of a further embodiment, the main chain and/or the at least one side chain, for example the at least two or three side chains, of the at least one lithium-ion conductive polymer of the at least one polymer electrolyte of the at least one contact layer encompasses at least one ether-encompassing repeating unit, in particular at least one ethylene oxide-based repeating unit and/or at least one oligo- or polyether-substituted, for instance acrylate-based, repeating unit, and/or a polyether, in particular a polyethylene oxide, and/or at least one, in particular oligo- or polyether-substituted, acrylate-based repeating unit, and/or an, in particular oligo- or polyether-substituted, polyacrylate, and/or at least one carbonate-based repeating unit and/or a polycarbonate, and/or at least one siloxane-based repeating unit and/or a polysiloxane, and/or at least one sulfide-based repeating unit, for example an alkylene sulfide-based, for instance ethylene sulfide-based, repeating unit and/or a sulfide-based polymer, for example a polyalkylene sulfide, for instance polyethylene sulfide.

If applicable, the main chain and/or the at least one side chain, for example the at least two or three side chains, can furthermore encompass at least one styrene-based unit and/or a polystyrene. Mechanical stability can thereby advantageously be enhanced.

In the context of a further embodiment, the main chain and/or the at least one side chain, in particular the at least two or three side chains, of the at least one lithium-ion conductive polymer of the at least one polymer electrolyte of the at least one contact layer at least encompasses at least one ether-encompassing repeating unit, in particular at least one ethylene oxide-based repeating unit and/or at least one oligo- and/or polyether-substituted repeating unit, and/or a polyether, in particular a polyethylene oxide, in particular as a lithium-ion conductive unit.

An “ethylene oxide-based repeating unit” can be understood in particular as a repeating unit that is obtainable by polymerization of ethylene oxide and/or of an ethylene oxide derivative that is derivable, for instance, by single or multiple substitution and/or functionalization of ethylene oxide.

Ether-encompassing repeating units, in particular ethylene oxide-based repeating units and/or oligo- or polyether-substituted repeating units, and/or polyethers, in particular polyethylene oxides, in the main chain and/or in the side chain or side chains, advantageously make it possible to achieve both high flexibility and softness, for example a low shear modulus, and/or high adaptability, and high intrinsic lithium-ion conductivity.

In particular, the main chain and the at least one side chain, for example the at least two or three side chains, of the at least one lithium-ion conductive polymer of the at least one polymer electrolyte of the at least one contact layer can therefore at least encompass at least one ether-encompassing repeating unit, in particular at least one ethylene oxide-based repeating unit and/or at least one oligo- or polyether-substituted repeating unit, and/or a polyether, in particular a polyethylene oxide, in particular as lithium-ion conductive units.

The at least one lithium-ion conductive polymer of the at least one polymer electrolyte of the at least one contact layer can furthermore, as applicable, at least encompass at least one further repeating unit, for example at least one, for example oligo- or polyether-substituted, acrylate-based repeating unit, and/or a, for example oligo- or polyether-substituted, polyacrylate, and/or at least one carbonate-based repeating unit and/or a polycarbonate, and/or at least one siloxane-based repeating unit and/or a polysiloxane, and/or at least one sulfide-based repeating unit, for example an alkylene sulfide-based, for instance ethylene sulfide-based, repeating unit and/or a sulfide-based polymer, for example a polyalkylene sulfide, for instance polyethylene sulfide, and/or at least one styrene-based unit and/or a polystyrene. Further improvements in properties can thereby, for example, be achieved.

In the context of a further embodiment, the at least one lithium-ion conductive polymer of the at least one polymer electrolyte of the at least one contact layer (furthermore) has at least one functional group. Further improvements in properties can thereby, for example, be achieved. For instance, the at least one lithium-ion conductive polymer of the at least one polymer electrolyte of the at least one contact layer can have at least one functional group that is designed for contact improvement and/or for adhesion promotion between the at least one protective layer and the at least one contact layer, for instance at least one carboxy group and/or sulfonate group and/or carbonyl group. Attachment of the at least one contact layer to the at least one protective layer and/or to the electrode, in particular an anode and/or a cathode, can thereby advantageously be improved.

In an example embodiment, the main chain and/or the at least one side chain, in particular the at least two or three side chains, of the at least one lithium-ion conductive polymer of the at least one polymer electrolyte of the at least one contact layer is/are substituted with at least one contact-promoting and/or adhesion-promoting functional group. The at least one contact-promoting and/or adhesion-promoting functional group can, in particular, encompass or be a carboxy group and/or sulfonate group and/or carbonyl group. Carboxy, sulfonate, and/or carbonyl groups have proven to be particularly advantageous as contact-promoting and/or adhesion-promoting functional groups.

In an example embodiment, the at least one lithium conducting salt of the at least one polymer electrolyte of the at least one contact layer encompasses or is lithium bis(trifluoromethanesulfonyl)imide (LiTFSI) and/or lithium hexafluorophosphate (LiPF₆) and/or lithium bisoxalatoborate (LiBOB) and/or trifluoromethanesulfonate (Li triflate) and/or lithium perchlorate (LiClO₄) and/or lithium difluorooxalatoborate (LiDFOB) and/or lithium tetrafluoroborate (LiBF₄) and/or lithium bromide (LiBr) and/or lithium iodide (LiI) and/or lithium chloride (LiCl). In particular, the at least one lithium conducting salt of the at least one polymer electrolyte of the at least one contact layer can encompass or be lithium bis(trifluoromethanesulfonyl)imide (LiTFSI). Lithium bis(trifluoromethanesulfonyl)imide has proven to be particularly advantageous in terms of achieving high intrinsic lithium-ion conductivity.

In an example embodiment, the at least one lithium-ion conducting or lithium-ion conductive block copolymer of the at least one protective layer encompasses at least one block made of at least one single lithium-ion conducting polyelectrolyte and/or at least one block made of at least one lithium-ion conductive polymer, for example polyethylene oxide. The at least one lithium-ion conducting or lithium-ion conductive block copolymer can furthermore encompass or be at least one block made of at least one mechanically stabilizing polymer, for example polystyrene and/or polyacrylate.

The at least one single lithium-ion conducting polyelectrolyte of the at least one protective layer, and/or the at least one lithium-ion conducting or lithium-ion conductive block copolymer, in particular the at least one block made of at least one single lithium-ion conducting polyelectrolyte of the at least one block copolymer of the at least one protective layer, can encompass, for example, at least one, in particular single lithium-ion conducting, repeating unit of the general chemical formula:

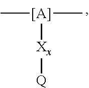

in particular

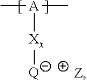

where -[A]- in particular denotes a polymer-backbone-forming unit; X in particular denotes a spacer, in particular a spacer bound, for example covalently, to the polymer-backbone-forming unit -[A]- or to the polymer backbone; x denotes in particular the number, in particular the presence or absence, of the spacer X; x can in particular be 1 or 0, for example 1. In the case where x=1, a spacer X can in particular be present. In the case where x=0, in particular no spacer can be present.

Q denotes in particular a negatively charged group Q and a counter-ion Z⁺. Q⁻ denotes in particular a negatively charged group Q⁻ that is bound, in particular covalently, to the spacer X (in the case where x=1) or to the polymer backbone -[A]- (in the case where x=0). Z⁺ denotes in particular a lithium ion Li⁺.

The negatively charged group Q can denote, for example, a group based on a conducting salt anion, in particular lithium conducting salt anion, for example a sulfonate ion, for example a (single) sulfonate anion (⁻SO₃₋) or a trifluoromethanesulfonate anion) (triflate, ⁻SO₃CF₂—) and/or a borate anion, in particular a trihaloborate anion, for example a trifluoroborate anion (—BF₃⁻) and/or a sulfonylimide anion, for example a trifluoromethanesulfonylimide anion (TFSI⁻: F₃C—SO₂—(N⁻)—SO₂—) and/or perfluoroethanesulfonylimide anion (PFSI⁻: F₅C₂—SO₂—(N⁻)—SO₂—) and/or fluorosulfonylimide anion (FSI: F—SO₂—(N⁻)—SO₂—), and/or a group based on an anion of an ionic liquid, for example a pyrazolide anion or an imidazolium anion, and/or a sulfate anion and/or a carboxylate anion and/or a phosphate anion and/or an amide anion, in particular a secondary amide anion, and/or a carboxylic acid amide anion, in particular a secondary carboxylic acid amide anion.

The spacer X can encompass, for example, at least one, in particular substituted or unsubstituted, saturated or unsaturated, linear or branched alkylene group and/or at least one, in particular substituted or unsubstituted, saturated or unsaturated, linear or branched alkylene oxide group and/or at least one, in particular substituted or unsubstituted, phenylene oxide group and/or at least one, in particular substituted or unsubstituted, phenylene group and/or at least one, in particular substituted or unsubstituted, benzylene group and/or at least one carbonyl group and/or at least one cyclic carbonate group and/or at least one lactone group and/or at least one cyclic carbamate group and/or at least one acyclic carbonate group and/or at least one acyclic carboxylic acid ester group and/or at least one acyclic carbamate group and/or at least one (ether) oxygen and/or at least one further negatively charged group.

-[A]- can denote, for example, a polymer-backbone-forming unit that encompasses (at least) one alkylene unit and/or one alkylene oxide unit, in particular ethylene oxide unit and/or propylene oxide unit, and/or a siloxane unit and/or a phosphazene unit and/or an acrylate unit, for example a methyl methacrylate unit and/or a methacrylate unit, and/or a phenylene unit, for example a para-phenylene unit, and/or a phenylene oxide unit and/or a benzylene unit.

The polymer-backbone-forming unit -[A]- can be both monofunctionalized and polyfunctionalized, for example bifunctionalized, trifunctionalized, or tetrafunctionalized, with the negatively charged group Q attached, as applicable, via the spacer X. A “polyfunctionalized” polymer-backbone-forming unit -[A]- can be understood in particular as a polymer-backbone-forming unit -[A]- that is functionalized with at least two negatively charged groups Q⁻, a respective negatively charged group Q⁻ in particular being attached, as applicable via a spacer X, to the polymer-backbone-forming unit -[A]-.

In an example embodiment, Q denotes at least one lithium trihaloborate group, in particular a lithium trifluoroborate group, and/or at least one lithium trihaloborate alkylene oxide group, in particular a lithium trihaloborate methylene oxide group, for example a lithium trifluoroborate alkylene oxide group, in particular a lithium trifluoroborate methylene oxide group, and/or at least one lithium alkanolate group, or an, in particular substituted or unsubstituted, lithium methanolate group.

In an example embodiment, the at least one lithium trihaloborate group encompasses or is at least one, in particular single, lithium trihaloborate group, in particular of the general formula —BY₃⁻ Lit, and/or at least one lithium trihaloborate alkylene oxide group, in particular lithium trihaloborate methylene oxide group, in particular of the general formula —CR1R2-O—BY₃⁻Li⁺, and/or at least one lithium trihaloborate oxide group, in particular of the general formula —O—BY₃⁻ Li⁺.

Y can denote in particular fluorine and/or chlorine and/or bromine and/or iodine, for example fluorine.

The alkylene oxide group, in particular methylene oxide group, can in particular be alkyl-substituted, for example methyl-substituted. For example, the alkylene oxide group, in particular methylene oxide group, can be doubly alkyl-substituted, for example doubly methyl-substituted.

R1 and R2 can be, for example, the same or different from one another, in particular the same, and can denote, for instance, hydrogen or an alkyl group, in particular an alkyl group, for example a methyl group or ethyl group or propyl group, in particular a methyl group.

In an example embodiment, the at least one lithium trihaloborate group encompasses or is at least one lithium trifluoroborate group. For example, the at least one lithium trihaloborate group or lithium trifluoroborate group can include at least one, in particular single, lithium trifluoroborate group, in particular of the formula —BF₃⁻Li⁺, and/or at least one lithium trifluoroborate alkylene oxide group, in particular lithium trifluoroborate methylene oxide group, in particular of the general formula —CR1R2-O—BF₃⁻Li⁺, and/or at least one lithium trifluoroborate oxide group, in particular of the formula —O—BF₃⁻Li⁺. The alkylene oxide group, in particular methylene oxide group, can in particular be alkyl-substituted, for example methyl-substituted. The alkylene oxide group, in particular methylene oxide group, can be alkyl-substituted, for example methyl-substituted. For example, the alkylene oxide group, in particular methylene oxide group, can be doubly alkyl-substituted, for example doubly methyl-substituted. R1 and R2 can be, for example, the same or different from one another, in particular the same, and can denote, for instance, hydrogen or an alkyl group, in particular an alkyl group, for example a methyl group or ethyl group or propyl group, in particular a methyl group.

In an alternative or additional example embodiment, the at least one lithium alkanolate group or, in particular substituted or unsubstituted, lithium methanolate group is alkyl-substituted, for example methyl-substituted. In particular, the at least one lithium alkanolate group or, in particular substituted or unsubstituted, lithium methanolate group can be doubly alkyl-substituted, for example doubly methyl-substituted. The at least one lithium alkanolate group or, in particular substituted or unsubstituted, lithium methanolate group can have, for example the general formula —CR1R2-O—Li⁺. The alkyl substituents, in particular R1 and R2, can e.g., be the same or different and/or can denote hydrogen or a methyl group or ethyl group or propyl group. For instance, the alkyl substituents, in particular R1 and R2, can be the same and/or can denote a methyl group. For instance, the at least one lithium alkanolate group or lithium methanolate group can encompass or be at least one lithium 1,1-methyl methanolate group (lithium 1,1-dimethyl methanolate group).

In an example embodiment, the at least one single lithium-ion conducting polyelectrolyte of the at least one protective layer, and/or the at least one lithium-ion conducting or lithium-ion conductive block copolymer, in particular the at least one block made of at least one single lithium-ion conducting polyelectrolyte of the at least one block copolymer, of the at least one protective layer, encompasses at least one, in particular single lithium-ion conducting, repeating unit of the general chemical formula:

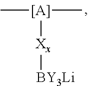

in particular,

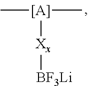

and/or

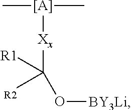

in particular

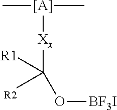

Y, R1, and/or R2 can be configured here and hereinafter, in particular, as explained above.

Polymer electrolytes of this kind are advantageously single lithium-ion conducting lithium polyelectrolytes.

In an example embodiment, the polymer-backbone-forming unit -[A]- denotes

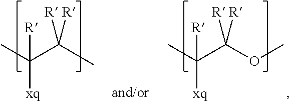

in particular

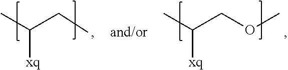

where xq denotes the attachment point of the spacer X and/or of the group Q.

In an alternative or additional example embodiment, the spacer X denotes a phenylene group, in particular a p-phenylene group, and/or an oxygen atom, in particular an ether oxygen, x being equal to 1.

For example, the at least one single lithium-ion conducting polyelectrolyte of the at least one protective layer, and/or the at least one lithium-ion conducting or lithium-ion conductive block copolymer, in particular the at least one block made of at least one single lithium-ion conducting polyelectrolyte of the at least one block copolymer, of the at least one protective layer, can encompass at least one, in particular single lithium-ion conducting, repeating unit of the general chemical formula:

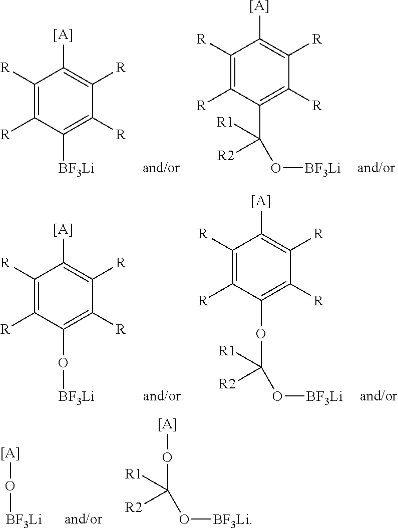

In an example embodiment, the at least one single lithium-ion conducting polyelectrolyte of the at least one protective layer, and/or the at least one lithium-ion conducting or lithium-ion conductive block copolymer, in particular the at least one block made of at least one single lithium-ion conducting polyelectrolyte of the at least one block copolymer, of the at least one protective layer, encompasses at least one, in particular single lithium-ion conducting, repeating unit of the general chemical formula:

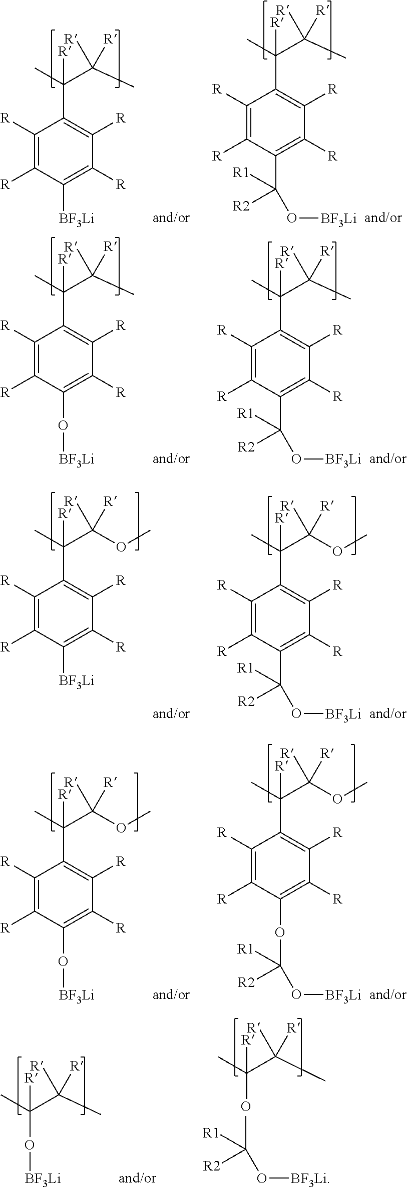

The R can denote, for example, mutually independently in each case, hydrogen or fluorine or a lithium-ion conductive substituent or an alkyl group, for example a methyl group or an ethyl group or a propyl group.

The R′ can denote, for example, mutually independently in each case, hydrogen or fluorine or a lithium-ion conductive substituent or an alkyl group, for example a methyl group or an ethyl group or a propyl group.

The lithium-ion conductive substituent can encompass, for example, at least one, for example incorporated or terminal, carboxylic acid ester group, for instance an acyclic or cyclic carbonate group and/or ester group and/or lactone group, in particular an acyclic or cyclic carbonate group, and/or at least one alkylene oxide group, for example an ethylene oxide group, in particular an oligo- or polyalkylene oxide group, for instance an oligo- or polyethylene oxide group, and/or optionally at least one polysiloxane group and/or optionally at least one alkylene group, for example a methylene group and/or ethylene group and/or propylene group, and/or optionally at least one, for example terminal, alkyl group, for example methyl group.

For example, the R and/or R′ can denote fluorine and/or a lithium-ion conductive substituent. Lithium ion mobility can thereby advantageously be increased. Or R′ and/or R can denote hydrogen. Manufacture can thereby advantageously be simplified.

The R and/or R′ can be configured hereinafter, in particular, as explained above.

In the context of a configuration of this embodiment, the at least one single lithium-ion conducting polyelectrolyte of the at least one protective layer, and/or the at least one lithium-ion conducting or lithium-ion conductive block copolymer, in particular the at least one block made of at least one single lithium-ion conducting polyelectrolyte of the at least one block copolymer, of the at least one protective layer, can encompass at least one, in particular single lithium-ion conducting, repeating unit of the general chemical formula:

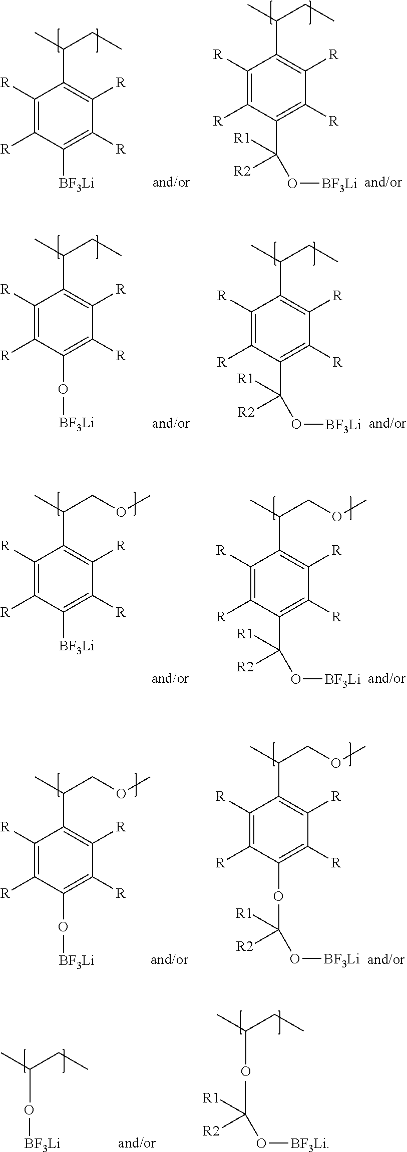

Polymer electrolytes having such repeating units can advantageously be manufactured from particularly inexpensive, readily obtainable, and/or environmentally friendly starting materials.

In an alternative or additional example embodiment, the at least one single lithium-ion conducting polyelectrolyte of the at least one protective layer, and/or the at least one lithium-ion conducting or lithium-ion conductive block copolymer, in particular the at least one block made of at least one single lithium-ion conducting polyelectrolyte of the at least one block copolymer, of the at least one protective layer, can encompass at least one, in particular single lithium-ion conducting, repeating unit of the general chemical formula:

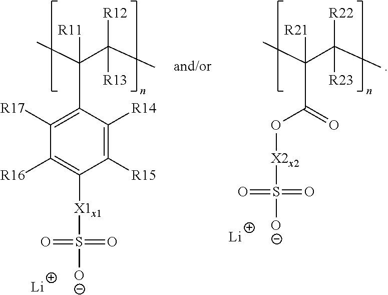

in which R11 to R17 and R21 to R23 each, in particular mutually independently in each case, respectively denote hydrogen or fluorine or a lithium-ion conductive substituent or an alkyl group. X1 and X2 respectively denote, in particular, a spacer, which for example encompasses at least one oxygen atom and/or at least one, in particular substituted or unsubstituted, saturated or unsaturated, linear or branched alkylene group and/or at least one, in particular substituted or unsubstituted, saturated or unsaturated, linear or branched, alkylene oxide group, in particular ethylene oxide group, and/or at least one, in particular substituted or unsubstituted, phenylene oxide group and/or at least one, in particular substituted or unsubstituted, phenylene group and/or at least one, in particular substituted or unsubstituted, benzylene group and/or at least one carbonyl group. x1 and x2 respectively denote, in particular, the number, in particular the presence or absence, respectively of spacers X1 and X2 and can be 1 or 0; for example, for 1 a spacer X1 or X2 is respectively present, and for 0 no spacer X1 or X2 is present.

The lithium-ion conductive substituent can encompass, for instance, at least one, for example incorporated or terminal, carboxylic acid ester group, for instance an acyclic or cyclic carbonate group and/or ester group and/or lactone group, in particular an acyclic or cyclic carbonate group, and/or at least one alkylene oxide group, for example an ethylene oxide group, in particular an oligo- or polyalkylene oxide group, for instance an oligo- or polyethylene oxide group, and/or optionally at least one polysiloxane group and/or optionally at least one alkylene group, for example a methylene group and/or ethylene group and/or propylene group, and/or optionally at least one, for example terminal, alkyl group, for example methyl group.

For example, the at least one single lithium-ion conducting polyelectrolyte of the at least one protective layer, and/or the at least one lithium-ion conducting or lithium-ion conductive block copolymer, in particular the at least one block made of at least one single lithium-ion conducting polyelectrolyte of the at least one block copolymer, of the at least one protective layer, can encompass at least one, in particular single lithium-ion conducting, repeating unit of the general chemical formula:

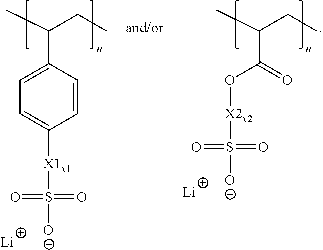

In an example embodiment, the at least one single lithium-ion conducting polyelectrolyte of the at least one protective layer and/or the at least one lithium-ion conducting or lithium-ion conductive block copolymer of the at least one protective layer further encompasses at least one lithium-ion conductive repeating unit.

For example, the at least one single lithium-ion conducting polyelectrolyte of the at least one protective layer, and/or the at least one lithium-ion conducting or lithium-ion conductive block copolymer, in particular the at least one block made of at least lithium-ion conductive polymer of the at least one block copolymer, of the at least one protective layer, and/or the at least one lithium-ion conductive polymer of the at least one polymer electrolyte and/or the at least one polymer electrolyte of the at least one contact layer, can (furthermore) encompass encompasses [sic] at least one lithium-ion conductive repeating unit of the general chemical formula:

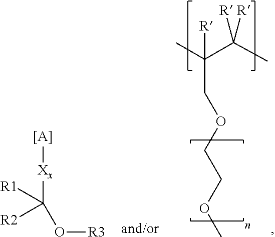

for example

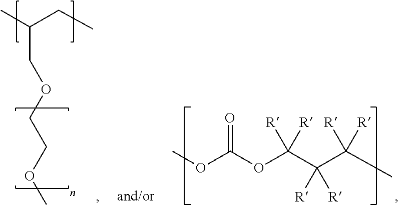

for example

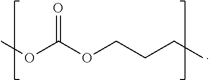

For example, the at least one single lithium-ion conducting polyelectrolyte of the at least one protective layer, and/or the at least one lithium-ion conducting or lithium-ion conductive block copolymer, in particular the at least one block made of at least one lithium-ion conductive polymer of the at least one block copolymer, of the at least one protective layer, and/or optionally the at least one lithium-ion conductive polymer of the at least one polymer electrolyte and/or the at least one polymer electrolyte of the at least one contact layer, can (furthermore) encompass at least one lithium-ion conductive repeating unit of the general chemical formula:

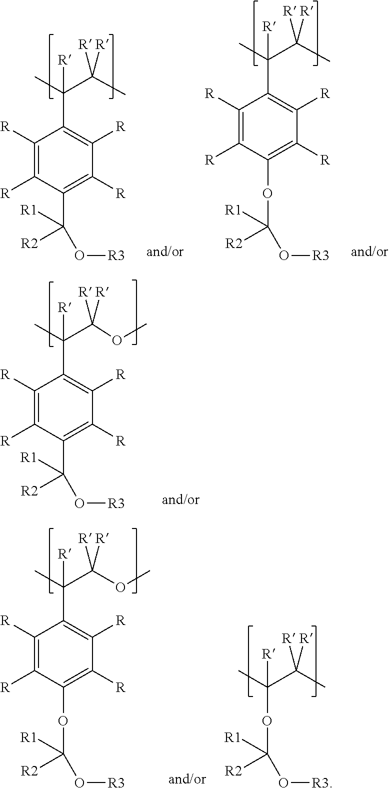

R3 here can encompass or be in particular at least one, for example incorporated or terminal, carboxylic acid ester group, for instance an acyclic or cyclic carbonate group and/or ester group and/or lactone group, in particular an acyclic or cyclic carbonate group, and/or at least one alkylene oxide group, for example an ethylene oxide group, in particular an oligo- or polyalkylene oxide group, for instance an oligo- or polyethylene oxide group, and/or at least one polysiloxane group. In particular, R3 can encompass or be at least one, for example incorporated or terminal, carboxylic acid ester group, for instance an acyclic or cyclic carbonate group and/or ester group and/or lactone group, in particular an acyclic or cyclic carbonate group. For instance, R3 can encompass at least one, or also several, such groups, and for instance can encompass or be a mono-, oligo-, or polycarbonate. R3 can also, however, for example also encompass or be at least one carboxylic acid ester group, for instance an acyclic or cyclic carbonate group and/or ester group and/or lactone group, in particular an acyclic or cyclic carbonate group, and at least one alkylene oxide group, for example an ethylene oxide group, in particular an oligo- or polyalkylene oxide group, for example an oligo- or polyethylene oxide group. The at least one carboxylic acid ester group can encompass or be in particular a terminal cyclic carbonate group and/or ester group and/or lactone group and/or an incorporated acyclic carbonate group. R3 can furthermore encompass at least one alkylene group, for example a methylene group and/or ethylene group and/or propylene group, and/or for example at least one, for example terminal, alkyl group, for instance methyl group. For instance, R3 can encompass or be an, in particular alkyl-terminated, for example methyl-terminated, poly(alkylenecarbonate), for example of the general chemical formula —(O—C═O—O—CH₂—CH₂—CH₂)ₚ—CH₃ and/or an, in particular alkyl-terminated, for example methyl-terminated, oligo- or polyethylene oxide, in particular polyethylene glycol, for example of the formula —(CH₂—CH₂—O)ₚ—CH₃.

For instance, the at least one single lithium-ion conducting polyelectrolyte of the at least one protective layer, and/or the at least one lithium-ion conducting or lithium-ion conductive block copolymer, in particular the at least one block made of at least one lithium-ion conductive polymer of the at least one block copolymer, of the at least one protective layer, and/or optionally the at least one lithium-ion conductive polymer of the at least one polymer electrolyte and/or the at least one polymer electrolyte of the at least one contact layer, can (furthermore) encompass at least one lithium-ion conductive repeating unit of the general chemical formula:

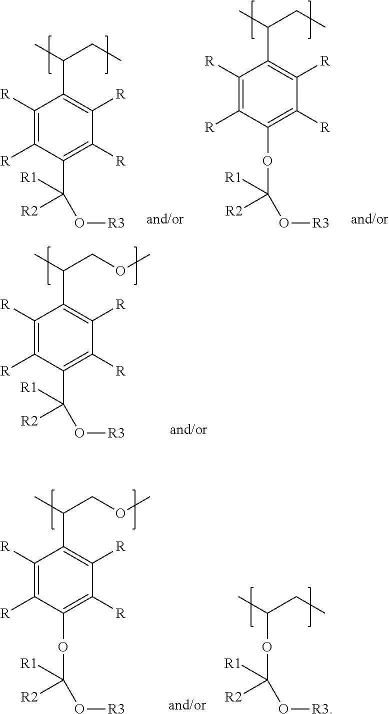

In an example embodiment, the at least one single lithium-ion conducting polyelectrolyte of the at least one protective layer and/or the at least one lithium-ion conducting or lithium-ion conductive block copolymer of the at least one protective layer (furthermore) encompasses at least one mechanically stabilizing repeating unit.

A “mechanically stabilizing repeating unit” can be understood in particular as a repeating unit that encompasses rigid groups, in particular aromatic groups. For example, the mechanically stabilizing repeating unit can encompass an aromatic group. For instance, the mechanically stabilizing repeating unit can be a styrene- and/or phenylene-based unit. The at least one mechanically stabilizing repeating unit can be designed in particular to constitute a mechanically stabilizing polymer. For example, the at least one mechanically stabilizing repeating unit can encompass or be a styrene- and/or alkylstyrene-based repeating unit.

In the context of a further embodiment, the at least one single lithium-ion conducting polyelectrolyte of the at least one protective layer, and/or the at least one lithium-ion conducting or lithium-ion conductive block copolymer of the at least one protective layer, and/or optionally the at least one lithium-ion conductive polymer of the at least one polymer electrolyte, and/or the at least one polymer electrolyte of the at least one contact layer, is a copolymer, for example a block copolymer, for instance a di-block copolymer or a tri-block copolymer, that encompasses at least one single lithium-ion conducting repeating unit, for example at least one single lithium-ion conducting repeating unit described above, and at least one lithium-ion conductive repeating unit, for example at least one lithium-ion conductive repeating unit described above, and/or at least one mechanically stabilizing repeating unit, for example at least one styrene- and/or alkylstyrene-based repeating unit.

In the context of a further embodiment, the at least one single lithium-ion conducting polyelectrolyte of the at least one protective layer, and/or the at least one lithium-ion conducting or lithium-ion conductive block copolymer of the at least one protective layer, and/or optionally the at least one lithium-ion conductive polymer of the at least one polymer electrolyte, and/or the at least one polymer electrolyte of the at least one contact layer, is a constituent of a polymer mixture that (further) includes at least one single lithium-ion conducting polyelectrolyte, for example having at least one single lithium-ion conducting repeating unit described above, and at least one lithium-ion conductive polymer, for example having at least one lithium-ion conductive repeating unit described above, and/or at least one mechanically stabilizing polymer, for example at least one styrene- and/or alkylstyrene-based polymer.

Suitable single lithium-ion conducting polyelectrolytes are described, for example, in the document WO 2015/185337 A2 and in DE 10 2016 207 081.9.

The properties, for instance the intrinsic lithium-ion conductivity and/or the hardness, for example the shear modulus, of the at least one single lithium-ion conducting polyelectrolyte and/or of the at least one lithium-ion conducting or lithium-ion conductive block copolymer of the at least one protective layer, and/or of the at least one polymer electrolyte, in particular of the at least one lithium-ion conductive polymer of the at least one polymer electrolyte, of the at least one contact layer, can advantageously be adjusted very effectively by way of the polymer backbone and/or side chains and/or the molecular weight and/or repeating unit(s) and/or functional groups and/or copolymerization.

The at least one single lithium-ion conducting polyelectrolyte of the at least one protective layer, and/or the at least one lithium-ion conducting or lithium-ion conductive block copolymer, for example of the at least one block made of at least one single lithium-ion conducting polyelectrolyte of the at least one block copolymer, of the at least one protective layer, can in particular encompass at least one repeating unit having a rigid polymer-backbone-forming and/or having bulky side groups and/or can have a high glass transition temperature, for example >100° C., and/or can be crosslinked. The hardness, for example the shear modulus, of the at least one single lithium-ion conducting polyelectrolyte, and/or of the at least one lithium-ion conducting or lithium-ion conductive block copolymer, of the at least one protective layer can thereby be enhanced.

In an example embodiment, the at least one single lithium-ion conducting polyelectrolyte of the at least one protective layer, and/or the at least one lithium-ion conducting or lithium-ion conductive block copolymer, for example the at least one block made of at least one single lithium-ion conducting polyelectrolyte of the at least one block copolymer, of the at least one protective layer, therefore encompasses at least one styrene-based repeating unit and/or a polystyrene and/or at least one acrylate-based repeating unit and/or a polyacrylate. Acrylate-based repeating units and/or polyacrylates can, in particular, be crosslinked.

It is thereby possible to constitute a mechanically stable and/or rigid polymer backbone and thereby to prevent lithium dendrites from perforating the at least one protective layer, and thereby to extend the service life of the lithium cell and/or lithium battery.

A “styrene-based repeating unit” can be understood in particular as a repeating unit that is obtainable by polymerization of styrene and/or of a styrene derivative that is derivable from styrene, for example, by single or multiple substitution and/or functionalization.

An “acrylate-based repeating unit” can be understood in particular as a repeating unit that is obtainable by polymerization of acrylate ester and/or of an acrylate ester derivative that is derivable from acrylic acid, for example, by single or multiple substitution and/or functionalization.

The at least one single lithium-ion conducting polyelectrolyte of the at least one protective layer, and/or the at least one lithium-ion conducting or lithium-ion conductive block copolymer of the at least one protective layer, can furthermore encompass at least one further repeating unit. Further improvements in properties can thereby, for example, be achieved. For instance, the at least one single lithium-ion conducting polyelectrolyte of the at least one protective layer, and/or the at least one lithium-ion conducting or lithium-ion conductive block copolymer of the at least one protective layer, can encompass at least one further repeating unit that is designed, for example, to improve contact between the at least one protective layer and the at least one contact layer.

The at least one single lithium-ion conducting polyelectrolyte of the at least one protective layer, and/or the at least one lithium-ion conducting or lithium-ion conductive block copolymer, for example the at least one block made of at least one single lithium-ion conducting polyelectrolyte and/or the at least one block made of at least one lithium-ion conductive polymer of the at least one block copolymer, of the at least one protective layer, can furthermore encompass at least one further functional group. Further improvements in properties can thereby, for example, be achieved. For instance, the at least one single lithium-ion conducting polyelectrolyte of the at least one protective layer, and/or the at least one lithium-ion conducting or lithium-ion conductive block copolymer, for example the at least one block made of at least one single lithium-ion conducting polyelectrolyte and/or the at least one block made of at least one lithium-ion conductive polymer of the at least one block copolymer, of the at least one protective layer, can encompass at least one further functional group that is designed, for example, to improve contact between the at least one protective layer and the at least one contact layer, for instance at least one carboxy group and/or sulfonate group and/or carbonyl group. The attachment of the at least one contact layer to the at least one protective layer and/or to the electrode, in particular an anode and/or a cathode, can thereby advantageously be further improved.

In the context of a further alternative or additional embodiment, the at least one single lithium-ion conducting polyelectrolyte of the at least one protective layer, and/or the at least one lithium-ion conducting or lithium-ion conductive block copolymer, for example the at least one block made of at least one single lithium-ion conducting polyelectrolyte of the at least one block copolymer, of the at least one protective layer, encompasses lithium sulfonate groups and/or lithium trifluoroborate groups and/or lithium carboxylate groups, in particular lithium trifluoroborate groups and/or lithium sulfonate groups. By way of lithium trifluoroborate groups and/or lithium sulfonate groups in particular, it is advantageously possible to achieve a comparatively weak coordination of cations, in particular lithium ions, which therefore increases ion mobility and ion conductivity.

For instance, the at least one single lithium-ion conducting polyelectrolyte of the at least one protective layer, and/or the at least one lithium-ion conducting or lithium-ion conductive block copolymer, for example the at least one block made of at least one single lithium-ion conducting polyelectrolyte of the at least one block copolymer, of the at least one protective layer, can encompass or be styrene-based repeating units functionalized with lithium sulfonate groups and/or a polystyrene functionalized with lithium sulfonate groups and/or, in particular crosslinked, acrylate-based repeating units functionalized with lithium sulfonate groups and/or, in particular crosslinked, polyacrylate functionalized with lithium sulfonate groups.

In an example embodiment, the at least one inorganic, in particular ceramic and/or glass-like, lithium-ion conductor of the at least one protective layer encompasses or is at least one sulfide glass and/or at least one lithium argyrodite and/or at least one lithium-ion conductor having a garnet structure, for instance based on the chemical formula Li₇La₃Zr₂O₁₂, and/or having a perovskite structure, for example a lithium lanthanum titanium oxide (LLTO), for instance based on the general chemical formula Li₃ₓLa_{2/3-x}TiO₃, and/or phosphate-based, for example a lithium titanium phosphate such as a lithium aluminum titanium phosphate and/or lithium gallium titanium phosphate and/or lithium indium titanium phosphate and/or lithium scandium titanium phosphate (LATP), for example based on the general chemical formula Li₁₊ₓTi₂₋ₓMₓ(PO₄)₃, where M denotes aluminum (Al) and/or gallium (Ga) and/or indium (In) and/or scandium (Sc). The at least one inorganic, in particular ceramic and/or glass-like, lithium-ion conductor can in particular be an inorganic, in particular ceramic and/or glass-like, single lithium-ion conductor. An “inorganic single lithium-ion conductor” can be understood in particular as an inorganic, in particular ceramic and/or glass-like, material in which only lithium ions (Lit) are mobile, and in which their counter-ions are immobile, for example incorporated into a salt lattice.

In an example embodiment, the at least one inorganic, in particular glass-like and/or ceramic, lithium-ion conductor, in particular single lithium-ion conductor, encompasses or is at least one sulfide glass and/or at least one lithium argyrodite. Sulfide glasses and/or lithium argyrodites have proven to be particularly advantageous because they can exhibit high lithium-ion conductivity and low contact resistance values at the grain boundaries within the material and with further components. Sulfide glasses and/or lithium argyrodites can furthermore be ductile, and for that reason can be used particularly advantageously with porous materials and/or materials having a rough surface.

Examples of lithium argyrodites are:
compounds of the general chemical formula:

Li₇PCh₆

where Ch denotes sulfur (S) and/or oxygen (O) and/or selenium (Se), for example sulfur (S) and/or selenium (Se), in particular sulfur (S);
compounds of the general chemical formula:

Li₆PCh₅X

where Ch denotes sulfur (S) and/or oxygen (O) and/or selenium (Se), for example sulfur (S) and/or oxygen (O), in particular sulfur (S), and X denotes chlorine (Cl) and/or bromine (Br) and/or iodine (I) and/or fluorine (F), for example X denotes chlorine (Cl) and/or bromine (Br) and/or iodine (I); and
compounds of the general chemical formula:

Li_{7-δ}BCh_{6-δ}X_{δ}

where Ch denotes sulfur (S) and/or oxygen (O) and/or selenium (Se), for example sulfur (S) and/or selenium (Se), in particular sulfur (S), B denotes phosphorus (P) and/or arsenic (As), X denotes chlorine (Cl) and/or bromine (Br) and/or iodine (I) and/or fluorine (F), for example X denotes chlorine (Cl) and/or bromine (Br) and/or iodine (I), and 0≤δ≤1.

For instance, the at least lithium-ion conductor, in particular single lithium-ion conductor, can encompass at least one lithium argyrodite of the chemical formula Li₇PS₆, Li₇PSe₆, Li₆PS₅Cl, Li₆PS₅Br, Li₆PS₅I, Li_{7-δ}PS_{6-δ}Cl_{δ}, Li_{7-δ}PS_{6-δ}Br_{δ}, Li_{7-δ}PS_{6-δ}I_{δ}, Li_{7-δ}PSe_{6-δ}Cl_{δ}, Li_{7-δ}PSe_{6-δ}Br_{δ}, Li_{7-δ}PSe_{6-δ}I_{δ}, Li_{7-δ}AsS_{6-δ}Br_{δ}, Li_{7-δ}AsS_{6-δ}I_{δ}, Li₆AsS₅I, Li₆AsSe₅I, Li₆PO₅Cl, Li₆PO₅Br, and/or Li₆PO₅I. Lithium argyrodites are described, for example, in the documents: Angew. Chem. Int. Ed., 2008, 47, 755-758; Z. Anorg. Allg. Chem., 2010, 636, 1920-1924; Chem. Eur. J., 2010, 16, 2198-2206; Chem. Eur. J., 2010, 16, 5138-5147; Chem. Eur. J., 2010, 16, 8347-8354; Solid State Ionics, 2012, 221, 1-5; Z. Anorg. Allg. Chem., 2011, 637, 1287-1294; and Solid State Ionics, 2013, 243, 45-48.

The lithium argyrodite can in particular be a sulfidic lithium argyrodite, for instance in which Ch denotes sulfur (S).

Lithium argyrodites can be manufactured in particular by way of a mechanical/chemical reaction process, for instance in which starting materials such as lithium halides, for example LiCl, LiBr, and/or LiI, and/or lithium chalcogenides, for example Li₂S and/or Li₂Se and/or Li₂O, and/or chalcogenides of main group V, for example P₂S₅, P₂Se₅, Li₃PO₄, in particular in stoichiometric quantities, are milled together with one another. This can be accomplished, for example, in a ball mill, in particular in a high-energy ball mill, for instance at a rotation speed of 600 rpm. Milling can be accomplished in particular in an inert gas atmosphere.

For instance, the at least one inorganic lithium-ion conductor, in particular single lithium-ion conductor, can encompass at least one sulfide glass of the chemical formula Li₁₀GeP₂S₁₂, Li₂S—(GeS₂)—P₂S₅, and/or Li₂S—P₂S₅. For example, the at least one inorganic lithium-ion conductor, in particular single lithium-ion conductor, can encompass a germanium-containing sulfide glass, for instance Li₁₀GeP₂S₁₂ and/or Li₂S—(GeS₂)—P₂S₅, in particular Li₁₀GeP₂S₁₂. Sulfide glasses can advantageously exhibit high lithium-ion conductivity and chemical stability.

In particular, the at least one inorganic lithium-ion conductor, in particular single lithium-ion conductor, can encompass or be at least one lithium argyrodite(s). Lithium argyrodites are notable, advantageously, for particularly low contact resistance values at the grain boundaries within the material and with further components, for example the porous active-material particles. Particularly good ion conduction at and within the grain interfaces can thereby advantageously be achieved. Advantageously, lithium argyrodites can exhibit a low contact resistance between grains even without a sintering process. Production of the electrode and of the cell can thereby advantageously be simplified.

In an example embodiment, the at least one contact layer is softer than the at least one protective layer. In particular, the at least one polymer electrolyte of the at least one contact layer, in particular the at least one lithium-ion conductive polymer of the at least one polymer electrolyte of the at least one contact layer, can be softer than the at least one single lithium-ion conducting polyelectrolyte and/or the at least one lithium-ion conducting or lithium-ion conductive block copolymer and/or the at least one inorganic, in particular ceramic and/or glass-like, lithium-ion conductor of the at least one protective layer. For example, the at least one contact layer, for example the at least one polymer electrolyte of the at least one contact layer, in particular the at least one lithium-ion conductive polymer of the at least one polymer electrolyte of the at least one contact layer, can have a lower shear modulus than the at least one protective layer, in particular than the at least one single lithium-ion conducting polyelectrolyte and/or the at least one lithium-ion conducting or lithium-ion conductive block copolymer of the at least one protective layer.

For instance, the at least one protective layer, in particular the at least one single lithium-ion conducting polyelectrolyte and/or the at least one lithium-ion conducting or lithium-ion conductive block copolymer of the at least one protective layer, can have a shear modulus≥10⁷ Pa, for example ≥10⁸ Pa, for instance≥10⁹ Pa. A high shear modulus has proven to be advantageous in terms of preventing lithium dendrites and thus extending the service life of the lithium cell and/or lithium battery.

For instance, the at least one contact layer, for example the at least one polymer electrolyte of the at least one contact layer, in particular the at least one lithium-ion conductive polymer of the at least one polymer electrolyte of the at least one contact layer, can have a shear modulus<10⁷ Pa. A low shear modulus has proven to be advantageous in terms of improved contacting, and thus extending the service life of the lithium cell and/or lithium battery.

In an example embodiment, the at least one protective layer is equipped on both sides with a contact layer. In particular, the at least one protective layer can be coated on both sides with a contact layer. For example, the separator can be of sandwich-like configuration. Contacting between the at least one protective layer and other adjacent solid layers, for example the anode and the cathode, can thereby advantageously be further improved, and the service life can thus be further extended.

In an example embodiment, the at least one contact layer has a layer thickness (d) in a range from ≥500 nm to ≤5 μm.

In an example embodiment, the separator is a multiple-ply separator. In particular, the separator can have at least two protective layers and, for example, at least three contact layers. The dendrite resistance, and thus the service life, of a lithium cell and/or lithium battery outfitted therewith can thereby advantageously be further increased.

For instance, the separator can encompass at least one first, optionally outer, protective layer, and one second, optionally outer, protective layer. In particular, the outer side of the first (outer) protective layer can be equipped, in particular coated, with a first outer contact layer, and the outer side of the second (outer) protective layer with a second outer contact layer. In particular, at least one inner contact layer can be embodied between the first and the second (outer) contact layer.

In an example embodiment, at least one inner protective layer can be disposed between the first (outer) protective layer and the second (outer) protective layer. A respective inner contact layer can be constituted between the outer protective layers and the at least one inner protective layer and optionally between the inner protective layers.

In an example embodiment, the at least one contact layer, for example the at least one single lithium-ion conducting polyelectrolyte and/or the at least one polymer electrolyte, in particular the at least one lithium-ion conductive polymer, of the at least one contact layer, is manufactured by in situ polymerization on the at least one protective layer and/or on an electrode, for example an anode and/or a cathode, for instance on an electrode layer explained below, for example an anode layer and/or a cathode layer, and/or is applied by way of a coating process. Advantageously, contacting can be further improved, and the service life of a lithium cell and/or lithium battery outfitted therewith can be further extended, by way of in situ polymerization.

The at least one protective layer and/or the electrode, for example an anode and/or a cathode, for example the electrode layer explained below, for instance an anode layer and/or a cathode layer, can have been roughened prior to in situ polymerization and/or prior to the coating process. It is thereby possible, advantageously, to enlarge the contact surfaces and in that manner to further improve contacting and thereby further extend the service life of a lithium cell and/or lithium battery outfitted therewith.

The separator can be used both in exclusively solid-electrolyte lithium cells and/or lithium batteries and in lithium cells and/or lithium batteries that contain, in particular additionally, at least one liquid electrolyte. For example, the separator can therefore be designed for, and used in, a solid- and/or liquid-electrolyte lithium cell and/or lithium battery. In particular, the separator can be designed for, and used in, a lithium cell and/or lithium battery according to the present invention which is explained below.

With regard to further technical features and advantages of the separator according to the present invention, reference is made to the explanations in conjunction with the electrode according to the present invention, the cell and/or battery according to the present invention, the manufacturing method according to the present invention, and to the figures and the description of the figures.

According to an example embodiment, the invention furthermore relates to an electrode, in particular an anode and/or a cathode, for a lithium cell and/or lithium battery, in particular for a lithium metal cell and/or lithium metal battery, which encompasses an electrode layer, in particular an anode layer that, for example, encompasses metallic lithium, for instance a metallic lithium layer, and/or a cathode layer, at least one protective layer, and at least one contact layer. A contact layer is embodied at least between the electrode layer and the at least one protective layer.

The at least one protective layer encompasses, or is constituted from, in particular at least one single lithium-ion conducting polyelectrolyte and/or at least one lithium-ion conducting or lithium-ion conductive block copolymer and/or at least one inorganic, in particular ceramic and/or glass-like, lithium-ion conductor.

The at least one contact layer encompasses in particular at least one polymer electrolyte made of at least one lithium-ion conductive polymer and at least one lithium conducting salt, for example a combination of, for instance a mixture of, at least one lithium-ion conductive polymer and at least one lithium conducting salt. The at least one lithium-ion conductive polymer of the at least one polymer electrolyte of the at least one contact layer has in particular a main chain and at least one side chain. For example, the at least one lithium-ion conductive polymer of the at least one polymer electrolyte of the at least one contact layer can have at least two side chains.

The at least one protective layer and the at least one contact layer can furthermore, for example, be configured as explained in conjunction with the separator according to the example embodiments of the present invention.

The electrode can be used both in exclusively solid-electrolyte lithium cells and/or lithium batteries and in lithium cells and/or lithium batteries that contain, in particular additionally, at least one liquid electrolyte. For example, the electrode, for instance an anode or a cathode, can therefore be designed for, and used in, a solid- and/or liquid-electrolyte lithium cell and/or lithium battery. In particular, the electrode, for instance an anode or a cathode, can be designed for, and used in, a lithium cell and/or lithium battery according to the present invention which is explained below.

With regard to further technical features and advantages of the electrode according to the present invention, reference is herewith explicitly made to the explanations in conjunction with the separator according to the example embodiments of the present invention, the cell and/or battery according to the example embodiments of the present invention, the manufacturing method according to the example embodiments of the present invention, and to the figures and the description of the figures.

According to an example embodiment, the invention further relates to a lithium cell and/or lithium battery, in particular a lithium metal cell and/or lithium metal battery, which encompasses an anode that, for example, encompasses metallic lithium, for instance a metallic lithium anode; and a cathode. At least one protective layer and at least one contact layer are disposed or constituted between the anode and the cathode.

The at least one protective layer encompasses, or is constituted from, in particular at least one single lithium-ion conducting polyelectrolyte and/or at least one lithium-ion conducting or lithium-ion conductive block copolymer and/or at least one inorganic, in particular ceramic and/or glass-like, lithium-ion conductor.

The at least one contact layer encompasses in particular at least one polymer electrolyte made of at least one lithium-ion conductive polymer and at least one lithium conducting salt, for example a combination of, for instance a mixture of, at least one lithium-ion conductive polymer and at least one lithium conducting salt. The at least one lithium-ion conductive polymer of the at least one polymer electrolyte of the at least one contact layer has in particular a main chain and at least one side chain. For example, the at least one lithium-ion conductive polymer of the at least one polymer electrolyte of the at least one contact layer can have at least two side chains.

The at least one protective layer and the at least one contact layer can furthermore be configured, for example, as explained in conjunction with the separator according to the present invention.

In particular, a separator according to the present invention can be provided between the anode and the cathode, or the anode or the cathode can be an electrode according to the present invention.

The lithium cell and/or lithium battery can be an exclusively solid-electrolyte lithium cell and/or lithium battery that contains, in particular additionally, at least one liquid electrolyte. For example, the lithium cell and/or lithium battery can be a solid- and/or liquid-electrolyte lithium cell and/or lithium battery.

The lithium cell and/or lithium battery can, for example, be designed for and/or used in a vehicle, for example an electric vehicle and/or hybrid vehicle and/or a plug-in hybrid vehicle, and/or an electrical device, for example an electric power tool and/or garden tool, and/or an electronic device such as a laptop computer, PDA, and/or tablet PC, and/or a mobile telephone and/or another consumer application.

With regard to further technical features and advantages of the cell and/or battery according to the present invention, reference is herewith explicitly made to the explanations in conjunction with the separator according to the example embodiments of the present invention and the electrode according to the example embodiments of the present invention, the manufacturing method according to the example embodiments of the present invention, the figures and the description of the figures.

According to an example embodiment of the present invention, the invention relates to a method for manufacturing a separator, in particular a separator according to the present invention, and/or an electrode, in particular an electrode according to the present invention, for example an anode and/or a cathode, for a lithium cell and/or lithium battery, for example for a lithium metal cell and/or lithium metal battery, in particular for a lithium cell and/or lithium battery according to the present invention; and/or for manufacturing a lithium cell and/or lithium battery, for example a lithium metal cell and/or lithium metal battery, in particular a lithium cell and/or lithium battery according to the present invention, in which at least one protective layer and/or at least one electrode layer, in particular an anode layer that in particular encompasses metallic lithium, for example a metallic lithium anode, and/or a cathode layer, is coated with a material for constituting at least one contact layer, the at least one protective layer and/or the at least one electrode layer being roughened before coating, and/or the material for constituting at least one contact layer being polymerized, in particular in situ, on the at least one protective layer and/or on the at least one electrode layer. Roughening and/or in situ polymerization advantageously allows contacting to be (further) improved, and the service life of a lithium cell and/or lithium battery outfitted therewith thereby to be (further) extended.

The material for constituting at least one contact layer can in particular be designed to constitute a contact layer configured as explained in conjunction with the separator according to the present invention.

The at least one protective layer and/or the at least one electrode layer can be configured, for example, as explained in conjunction with the separator according to the present invention and/or the electrode according to the present invention.

A separator according to the present invention, or manufactured according to the present invention, and/or an electrode according to the present invention, or manufactured according to the present invention, and/or a lithium cell and/or lithium battery according to the present invention, or manufactured according to the present invention, can be analyzed, for example, using spectroscopic methods such as nuclear magnetic resonance (NMR) spectroscopy and/or infrared (IR) spectroscopy, and/or using surface analysis methods.

With regard to further technical features and advantages of the manufacturing method according to the present invention, reference is herewith explicitly made to the explanations in conjunction with the separator according to the example embodiments of the present invention and the electrode according to the example embodiments of the present invention and the lithium cell and/or lithium battery according to the example embodiments of the present invention, and to the figures and the description of the figures.

Further advantages and advantageous embodiments of the subject matter according to the present invention are illustrated by the drawings and explained in the description that follows. Be it noted in this context that the drawings are merely descriptive in nature and are not intended to limit the invention in any way.

### BRIEF DESCRIPTION OF THE DRAWINGS

FIG. 1 is a schematic cross section through a lithium cell and/or lithium battery according to an example embodiment of the present invention.

FIG. 2 is a schematic cross section through a separator having a sandwich-like configuration according to an example embodiment of the present invention.

FIG. 3 is a schematic cross section through a separator in the form of a multiple-ply separator, according to an example embodiment of the present invention.

### DETAILED DESCRIPTION

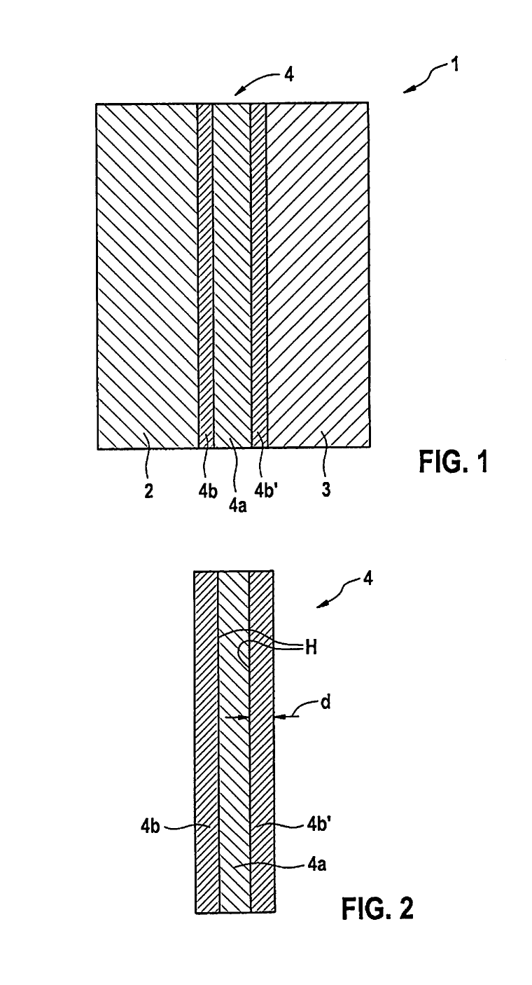

FIG. 1 shows an example in which a lithium cell and/or lithium battery 1 encompasses an anode 2, for example a metallic lithium anode, and a cathode 3. At least one protective layer 4a and at least one contact layer 4b, 4b′ are disposed between anode 2 and cathode 3.

Only one contact layer, for example an anode-side contact layer or a cathode-side contact layer, can be disposed (not depicted) between anode 2 and cathode 3; or, as depicted in FIG. 1, two contact layers 4b, 4b′, for example an anode-side contact layer 4b and a cathode-side contact layer 4b′, can be disposed between anode 2 and cathode 3.

Protective layer 4a is rigid, and serves to prevent lithium dendrites from growing through from anode 2 to cathode 3. Protective layer 4a for that purpose encompasses, or is constituted from, at least one single lithium-ion conducting polyelectrolyte and/or at least one lithium-ion conducting or lithium-ion conductive block copolymer and/or at least one inorganic, in particular ceramic and/or glass-like, lithium-ion conductor.

Contact layers 4b, 4b′ are softer than protective layer 4a, and serve as contact promoters between protective layer 4a and anode 2 on the one hand, and cathode 3 on the other hand. Contact layers 4b, 4b′ for that purpose encompass, or are constituted from, at least one polymer electrolyte that encompasses at least one lithium-ion conductive polymer having a main chain and at least one side chain, for example at least two side chains, and at least one lithium conducting salt. Contact layers 4b, 4b′ can be constituted identically to or differently from one another.

The contact layer/protective layer assemblage 4b, 4a, 4b′ shown in FIG. 1 can be both a constituent of a separator 4, for example in the form of a protective layer 4a equipped, for instance coated, on both sides with a respective contact layer 4b, 4b′, and a constituent of one or both electrodes 2, 3, for instance in the form of a layer assemblage made up of an electrode layer 2, 3, the one contact layer 4b, 4b′, and protective layer 4a, and optionally the other contact layer 4b′, 4b.

FIG. 2 shows a separator 4 according to an example embodiment of the present invention, having a sandwich-like configuration. The sandwich-like separator 4 has a protective layer 4a that is equipped, for example coated, on both sides with a respective contact layer 4b, 4b′, so that protective layer 4a is embedded into contact layers 4b, 4b′.

FIG. 2 further shows that contact layers 4b, 4b′ have, in particular adjacently to main surfaces H of protective layer 4a, a layer thickness d, for example, in a range from ≥500 nm to ≤5 μm.

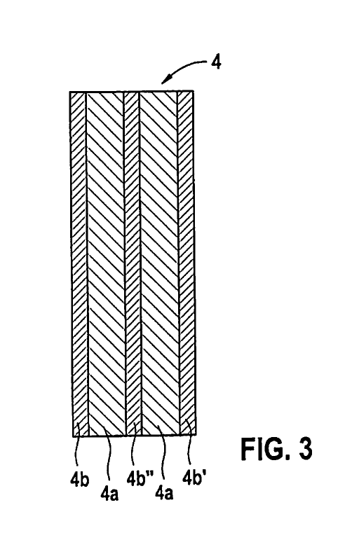

FIG. 3 shows an embodiment of a separator 4 in the form of a multiple-ply separator. Multiple-ply separator 4 has two protective layers 4a and three contact layers 4b, 4b′, 4b″. In particular, multiple-layer separator 4 encompasses a first and second protective layer 4a. An inner contact layer 4b″ is provided between first and second protective layer 4a. The outer sides of first and second protective layer 4a are furthermore each equipped, in particular coated, with an outer contact layer 4b, 4b′. The dendrite resistance of separator 4, and thus the service life of a lithium cell and/or lithium battery outfitted therewith, can advantageously be further increased by way of such a configuration.

What is claimed is:

1. A separator for a lithium cell or battery, the separator comprising:
at least one protective layer that includes at least one of:
at least one single lithium-ion conducting polyelectrolyte;
at least one lithium-ion conducting or lithium-ion conductive block copolymer; and
at least one inorganic lithium-ion conductor; and
at least one contact layer that includes at least one polymer electrolyte made of (a) at least one lithium-ion conductive polymer that includes a main chain and at least one side chain and (b) at least one lithium conducting salt.

2. The separator of claim 1, wherein the at least one side chain includes at least two side chains.

3. The separator of claim 1, wherein the at least one lithium-ion conductive polymer is at least one of a comb polymer and a branched polymer.

4. The separator of claim 1, wherein the at least one lithium-ion conductive polymer includes a hyper-branched polymer.

5. The separator of claim 1, wherein at least one of the main chain and the at least one side chain includes at least one of: (a) an ether-encompassing repeating unit, (b) a polyether, (c) an acrylate-based repeating unit, (d) a polyacrylate, (e) a carbonate-based repeating unit, (f) a polycarbonate, (g) a siloxane-based repeating unit, (h) a polysiloxane, (i) a sulfide-based repeating unit, and (j) a sulfide-based polymer.

6. The separator of claim 1, wherein at least one of the main chain and the at least one side chain includes an ether-encompassing repeating unit that includes at least one of at least one ethylene oxide-based repeating unit and at least one oligo- or polyether-substituted repeating unit.

7. The separator of claim 1, wherein at least one of the main chain and the at least one side chain includes a polyethylene oxide.

8. The separator of claim 1, wherein at least one of the main chain and the at least one side chain includes at least one of an acrylate-based repeating unit and a polyacrylate that is oligo- or polyether-substituted.

9. The separator of claim 1, wherein at least one of the main chain and the at least one side chain includes at least one of an ether-encompassing repeating unit that is at least one of (a) an ethylene oxide-based repeating unit, (b) an oligo- or polyether-substituted repeating unit, and (c) a polyethylene oxide.

10. The separator of claim 1, wherein at least one of the main chain and the at least one side chain is substituted with a functional group that is at least one of contact-promoting and adhesion-promoting and that includes at least one of a carboxy group, sulfonate group, and a carbonyl group.

11. The separator of claim 1, wherein the at least one lithium conducting salt of the at least one polymer electrolyte of the at least one contact layer includes lithium bis(trifluoromethanesulfonyl)imide.

12. The separator of claim 1, wherein the at least one lithium-ion conducting or lithium-ion conductive block copolymer includes a block made of at least one of (a) at least one single lithium-ion conducting polyelectrolyte and (b) at least one lithium-ion conductive polymer.

13. The separator of claim 1, wherein the at least one protective layer includes at least one of: (a) the at least one single lithium-ion conducting polyelectrolyte and (b) the at least one lithium-ion conducting or lithium-ion conductive block copolymer, which includes at least one of (i) a styrene-based repeating unit, a polystyrene, an acrylate-based repeating unit, a polyacrylate, a lithium sulfonate group, and a lithium trifluoroborate group.

14. The separator of claim 1, wherein:
the at least one protective layer includes at least one of: (a) the at least one single lithium-ion conducting polyelectrolyte and (b) the at least one lithium-ion conducting or lithium-ion conductive block copolymer, which includes at least one repeating unit of the general chemical formula of at least one of: 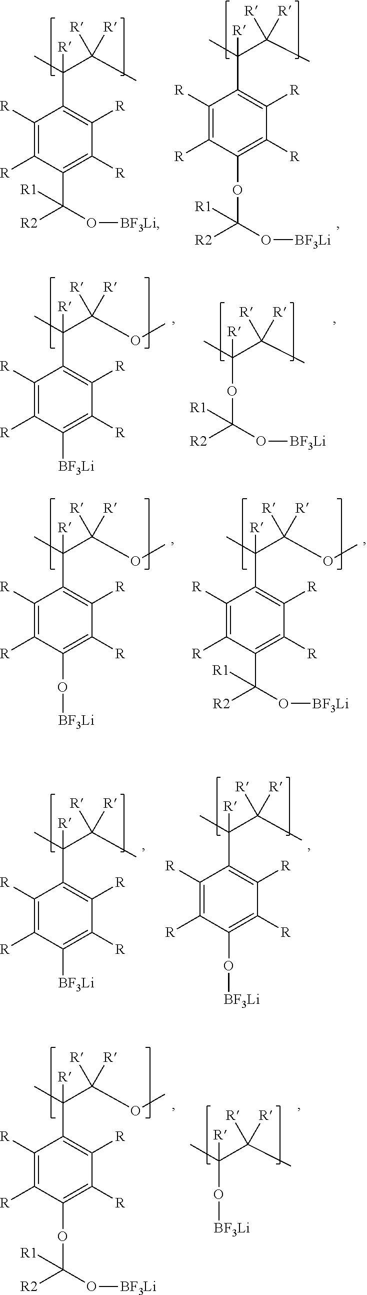 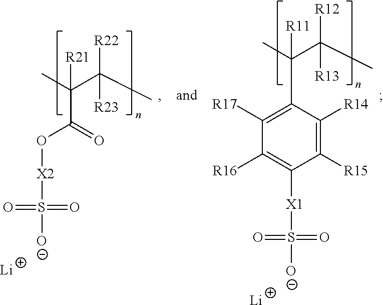
the R and R′, R11 to R17, and R21 to R23 each respectively denote hydrogen, fluorine, a lithium-ion conductive substituent, or an alkyl group;
X1 and X2 respectively denote a spacer; and
x1 and x2 respectively denote a respective number of spacers X1 and X2, and are 1 or 0.

15. The separator of claim 1, wherein the at least one protective layer includes that the at least one inorganic lithium-ion conductor, which (a) includes at least one of a sulfide glass, a lithium argyrodite, and a lithium-ion conductor and (b) at least one of has a garnet structure, has a perovskite structure, and (c) is phosphate-based.

16. The separator of claim 1, wherein the at least one contact layer is softer than the at least one protective layer.

17. The separator of claim 1, wherein a thickness (d) of the at least one contact layer is 500 nm≤d≤5 μm.

18. The separator of claim 1, wherein the lithium cell or battery is a lithium metal cell or battery.

19. The separator of claim 1, wherein the at least one inorganic lithium-ion conductor is ceramic or glass-like.

20. An electrode for a lithium cell or battery, the electrode comprising:
an electrode layer;
at least one protective layer that includes at least one of: (a) at least one single lithium-ion conducting polyelectrolyte, (b) at least one lithium-ion conducting or lithium-ion conductive block copolymer, and (c) at least one inorganic lithium-ion conductor; and
between the electrode layer and the at least one protective layer, a contact layer that includes at least one polymer electrolyte made of (a) at least one lithium-ion conductive polymer that includes a main chain and at least one side chain and (b) at least one lithium conducting salt.

21. The electrode of claim 20, wherein the electrode is an anode.

22. The electrode of claim 20, wherein the electrode layer is an anode layer including metallic lithium.

23. The electrode of claim 20, wherein the electrode is an cathode.

24. A lithium cell or battery comprising:
an anode;
a cathode; and
between the anode and the cathode, a separator that includes:
at least one protective layer that includes at least one of: (a) at least one single lithium-ion conducting polyelectrolyte, (b) at least one lithium-ion conducting or lithium-ion conductive block copolymer, and (c) at least one inorganic lithium-ion conductor; and
at least one contact layer that includes at least one polymer electrolyte made of (a) at least one lithium-ion conductive polymer that includes a main chain and at least one side chain and (b) at least one lithium conducting salt.

22. The lithium cell or battery of claim 24, wherein the anode or cathode is an electrode including an electrode layer, with the contact layer being arranged between the protective layer and the electrode layer.

23. The lithium cell or battery of claim 24, wherein the anode includes metallic lithium.
